(19) United States
(12) Patent Application Publication
(10) Pub. No.: US 2003/0220850 A1
(43) Pub. Date: Nov. 27, 2003

(54) Method and system for online managing product delivery

(76) Inventors: Te-Mei Chu, Taipei (TW); Shu-Mei Chien, Taipei (TW); Yun-Chi Lee, Taipei (TW); Kuan-I Wu, Taipei (TW)

Correspondence Address: BIRCH STEWART KOLASCH & BIRCH, PO BOX 747, FALLS CHURCH, VA, 22040-0747, US

(21) Appl. No.: 10/403,095

(22) Filed: Apr. 1, 2003

(30) Foreign Application Priority Data
May 21, 2002 (TW) 091110604

(51) Int. Cl. G06F 17/60

(52) U.S. Cl. 705/28

(57) ABSTRACT

A method and a system for managing online product delivery are provided. In operation, an order database for storing order data and a user database for storing data of delivery end users are established. So, a user at the purchase end only needs to input the new quantity of products to be delivered if the quantity of the order is to be modified. Once the buyer inputs a desirable quantity of products to be purchased into the system for managing product delivery, a quantity counting module would count the quantity of the current stock, maximum stocks, and product ordered by buyers, so as to display the maximum and minimum quantities of products available for delivery on a web page of the system for managing product delivery. Therefore, users at the delivery end are updated with the order details and the stocks of the buyers through a network system and a browser, to thereby make appropriate product delivery.

### FIELD OF THE INVENTION

The present invention relates to a method and system for online managing product delivery, and more particularly, to a method and system which links a purchase end to a delivery end in a trade deal through a web communication system, so that the delivery end is aware of the purchase end's stock quantity and demand.

### BACKGROUND OF THE INVENTION

As innovative technology continues to improve, a number of complex multifunctional products, such as desktop computers, hand phones and so on have eventually become many people's life necessities. These high-tech products are often composed of components developed in different fields with different functions. And instead of being produced by the factory manufacturer that is mainly in charge of an assembly job, the components are produced in an out source manner by a mid-stream or downstream Original Equipment Manufacturer (OEM) to reduce the production cost and the management risk.

For the current purchasing and delivering modes, the first mode being that the purchasing end user maintains a reference quantity of the stock and places order only when the quantity of the current stock is lower than the reference quantity. The second mode exists when the purchasing end user does not set the reference quantity of the stock or even adopts a zero stock management module, while the order is placed depending on the current or short term estimation of the production quantity. As for the third mode, the purchasing end user adopts a flexible stock mechanism depending on different scenarios. For instance, a mode to increase the stock is adopted for components with price expected to increase rapidly. Conversely, a low stock mode or a zero stock mode is adopted for huge volume components or components with constant and adequate supply.

There are both strengths and weaknesses in these three modes described above. And with the data being transmitted by Internet, the trading environment has already made progress towards immediacy and globalization. So, the manufacturer has to respond to variations expected from the trading market anytime during the manufacturing process. Otherwise, once the chance is missed, it is very likely to cause a loss in the production cost that is hard to be estimated.

On the other hand, the product storage requires a certain space, appropriate storage equipment, and professional managing personnel, all of which are associated with the production cost. Therefore, the manufacturer needs to consider the factors described above in order to reduce the production cost.

For conventional purchasing and delivering mechanisms, the purchase department in the purchasing end needs to confirm with the production unit for the required product quantity before inquiring the current stock quantity from the stock management department, so as to ascertain the purchase quantity. After that, the orders are transmitted to the delivering end by mail, fax, or e-mail. Once the delivering end receives the order, the delivery operation is immediately carried out according to the order. The product is then transported to the purchasing end based on the contract. And if either purchasing end or the delivering end needs to modify the content of the order, for example, specification or quantity of the product and even the delivering due date, both parties would have to modify and transmit the order again. As a result, a lot of time and money is wasted on transmitting the business document to and from both parties. Particularly, with concern of the time efficiency, the competitiveness of the manufacturing company would be affected if no response is made immediately to the order content or the delivery content.

To solve the above problems, including waste of resource and lack of immediacy associated with typical manual message transmission, an Electronic Data Interchange (EDI) is conducted through Internet by convention. In brief, it is a set of criteria for controlling transmission of the business documents (such as purchasing order, delivering list, and invoice) between computers. This system is established with objectives of omitting paper works and improving responding time. However, in order to make the exchange of electronic data more efficient, the user needs to follow certain criteria, such as X.400 protocol for formatting and exchanging data. So, the business document transmitted through the electronic data exchange saves more time than exchanging data or mail manually using conventional communication equipment. As described above, there are certain format criteria for transmitting data to each other, so the operation system needs to be integrated beforehand. As a result, the electronic data exchange is unable to be made epidemic to each user end of the Internet terminal device. Furthermore, even the data transmission and reception are achieved via electronic devices, there are still actions to be taken for transmitting electronic document file between the buyer and seller, and more actions means more time and money are wasted as well as occurrence of more errors.

### SUMMARY OF THE INVENTION

An objective of the present invention is to provide a method and system for online managing product delivery, so that a purchase end can count an available quantity of products to be delivered through the system for managing product delivery according to the present invention, in which the quantity can serve as a delivery reference for related delivery companies.

Another objective of the present invention is to provide a method and system for online managing product delivery, whereby the purchase end and the delivery end can alter the order detail and delivery detail in a specified web page.

In accordance with the above and other objectives, the present invention proposes a system for online managing product delivery, so that a seller can manage the product delivery online. The system for managing product delivery comprises: a stock managing work station for enabling a user of the purchase end to manage the stock quantity; a user database for storing user identification data of the purchase end and delivery end; an order database for storing the order detail; an invoice searching module for enabling the users of the purchase end and delivery end to search the order detail and delivery detail online; an invoice modifying module for modifying the detail of the order and delivery list by the users of the purchase end and delivery end; and a delivery quantity counting module for counting the quantity of current stock, the maximum quantity of the stock, and the quantity of current order.

In operation, the user of the purchase end enters an identification code, which allows the user identity verification module to search from the user database for the authority level entitled by the system of the present invention. An appropriate web page is displayed according to the authority level, from which the user of the purchase end searches or enters information. Next, the user end of the purchase end can search the order detail using the invoice searching module, while the quantity of the current order is entered through the invoice modifying module. After that, the delivery quantity counting module is commanded to execute a reciprocal calculation for the quantity of the order and the total checked quantity saved in the order database to obtain an allowable delivery quantity which is then saved in the order database. Lastly, the user end of the delivery end may follow the log-in steps for the user of the purchase end as described above, and enter the appropriate web page based on the authority level. Then, the system displays the order detail searched through the invoice searching module by the user of the delivery end, wherein the detail comprises at least the quantity of the purchase, the total checked quantity, and the maximum and minimum of allowable delivery quantity. Depending on a practical scenario, the allowable delivery quantity is altered in the delivery web page through the invoice modification module by the user of the delivery end.

With the method and system for online managing product delivery of the present invention, the user of the purchase end, especially purchasing operation personnel can get a hold of the quantity of the current order, quantity of the stock, and maximum and minimum quantity available for the delivery end anytime through the web communication system. On the other hand, the user of the delivery end is also aware of any changes in the order detail anytime through the web system, and responds to the industrial corporation of the purchase end according to the allowable delivery quantity online.

### BRIEF DESCRIPTION OF THE DRAWINGS

The present invention can be more fully understood by reading the following detailed description of the preferred embodiments, with reference made to the accompanying drawings, wherein:

FIG. 1 is a systemic diagram illustrating a basic structure of the system for online managing product delivery according to the present invention;

FIGS. 2(A) through 2(E) are schematic diagram illustrating the method for online managing product delivery and the system in operation; and

FIG. 3 is a flowchart illustrating process steps involved in managing product delivery through the use of the system for online managing product delivery.

### DETAILED DESCRIPTION OF THE PREFERRED EMBODIMENTS

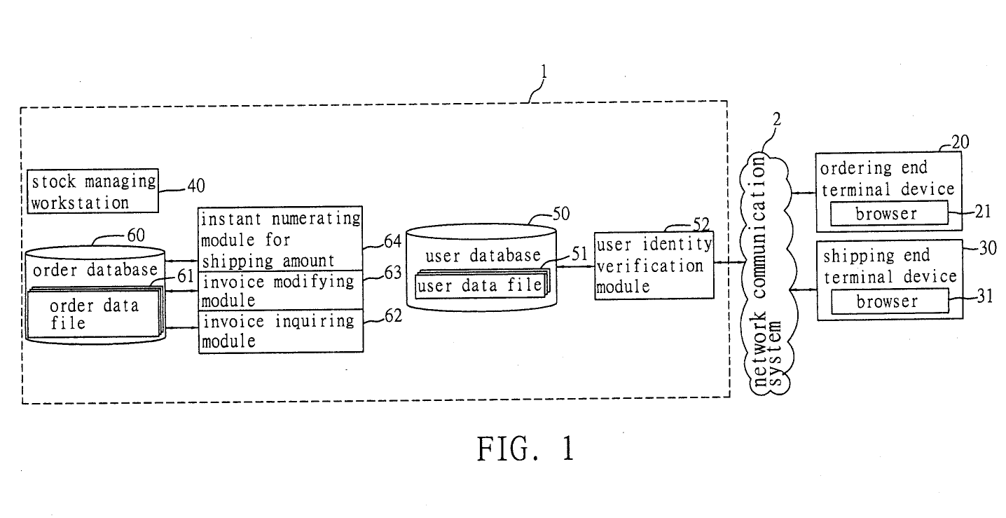

FIG. 1 illustrates a basic structure of the system for online managing product delivery according to the present invention. The system for online managing product delivery 1 enables a user located at a purchase end terminal device 20 to search a required order detail through a web communication system 2 of a browser 21 of the purchase end terminal device 20. Preferably, the system for online managing product delivery may be a huge enterprise computer system, and the web communication system 2 may include the system such as Internet, Intranet, and Extranet for linking the system for online managing product delivery 1 to the purchase end terminal device 20. On the other hand, a user of the delivery end can search the required order detail on a browser 31 of the delivery end terminal device 30 through the web communication system 2. The system for online managing product delivery 1 comprises at least a stock managing workstation 40, a user database 50, a user identity verification module 52, a order database 60, an invoice searching module 62, an invoice modifying module 63, and a delivery quantity counting module 64.

The stock managing workstation 40 enables the stock management control personnel to count quantity of the product stock stored in a warehouse or partial quantity of the products that have been submitted and checked by a delivery end supplier. A result of the count is then used to establish an order data corresponding to each purchase product. The stock managing workstation 40 may be a huge commercial computer system, and is integrally linked to other secondary server systems (not shown), such as an Enterprise Resource Planning (ERP) system, a Material Requirement Planning (MRP) system, and so on.

The user database 50 stores at least a plurality of user files 51, including those of the users of the purchase end and delivery end, wherein the users may be individuals or companies. Specifically, the users may be personnel in charge of purchasing or delivering operations.

The user files 51 comprise at least a plurality of user's basic identification data and a corresponding identification code, wherein the identification code serves to determine the authority level for the user who logs into the system for online managing product delivery.

And when the users of the purchase end or the delivery end enters the web page of the system for managing product delivery, the user identity verification module 52 requests the users to input the relevant identification data, such as the user name or name of the industrial corporation the user belongs to and individual code or identification code previously assigned. A set or multiple set of necessary identification data may be set beforehand, to enhance verification of the user's authority to be carried out more efficiently by the system of the present invention. Next, the identification data entered is matched with the user files 51 previously saved in the user database 50. After the identity of the user has been confirmed by the system for managing product delivery, the user identity verification module 52 commands the system for managing product delivery to display a web page corresponding to the authority level of the user, so as to enhance the user's operation.

The order database 60 serves to store a plurality of order files 61, wherein the order files comprise at least order details, such as the order quantity of products, total checked quantity, and maximum stock quantity. However, it should be noted that only those related to the present invention are illustrated in the present embodiment, while other order detail well known in a common deal would not be further described herein.

The invoice searching module 62 searches the order items based on conditions entered by the user, wherein the conditions may include a purchasing personnel code, a manufacturer code, a delivery factory area, an order number, a product material number, and so on. And an order file 61 that corresponds to the conditions is searched from the order database 60 before the system for managing product delivery is commanded to display the order files on the web page, from which the users of the purchase end and delivery end can search the order.

The invoice modification module 63 allows the user of the purchase end to alter the searched order content online according to the practical purchasing need. In the present embodiment, the system for managing product delivery specifically alters the order quantity of the product and the upper limit and the lower limit for the quantity allowable for delivery. That is, the system for managing product delivery makes alteration to the part related to the delivery quantity at the delivery end.

The delivery quantity counting module 64 performs an alternative calculation of the original or modified order quantity entered by the purchasing personnel, the original stock quantity in the stock management database in the backup system, and a part of the total checked quantity that has been submitted and checked. Finally, based on the characteristics of different products and factors such as warehouse space occupied by the products, difficulty in store keeping, rapid rise of the product price within a short time, and product supply shortage as well as maximum allowable stock quantity, an allowable delivery quantity reference value for the delivering end supplier is determined. It should be noted here that the upper limit and lower limit reference value for the allowable delivery quantity is the maximum allowable delivery quantity available for the delivering end supplier. Thus, the supplier can respond depending on the current supply status.

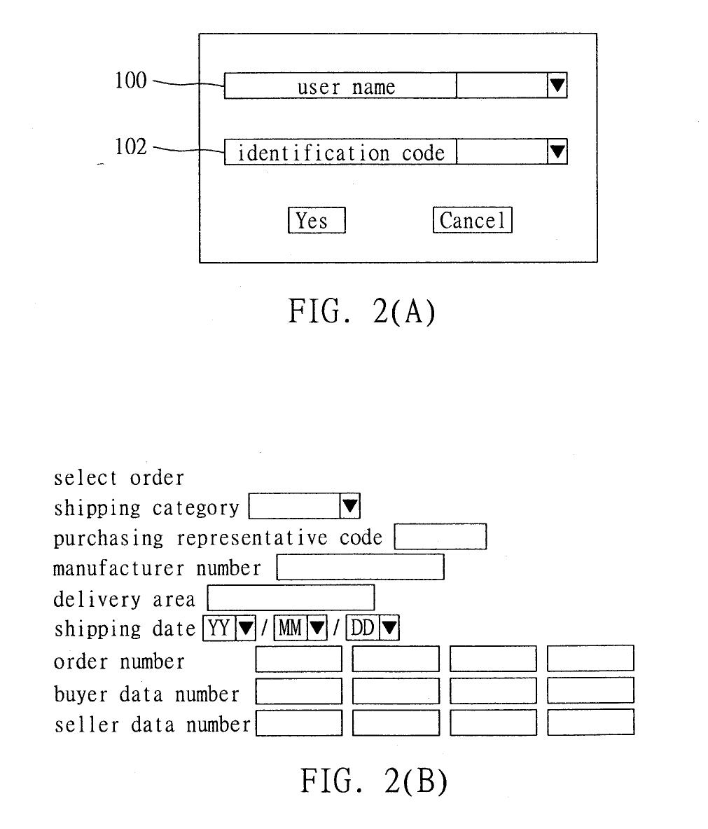

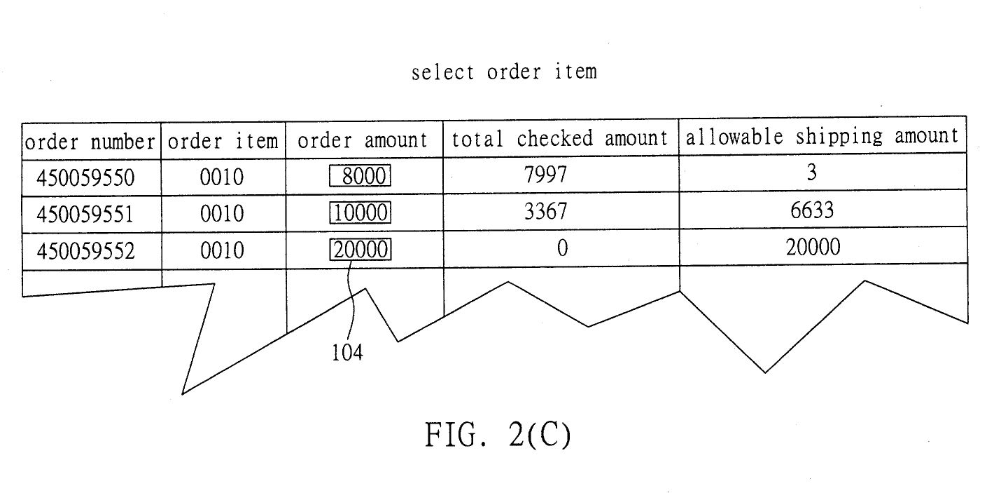

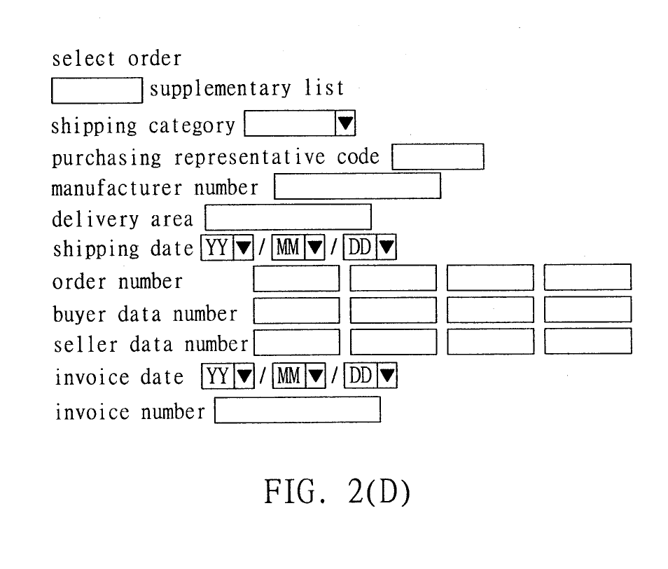

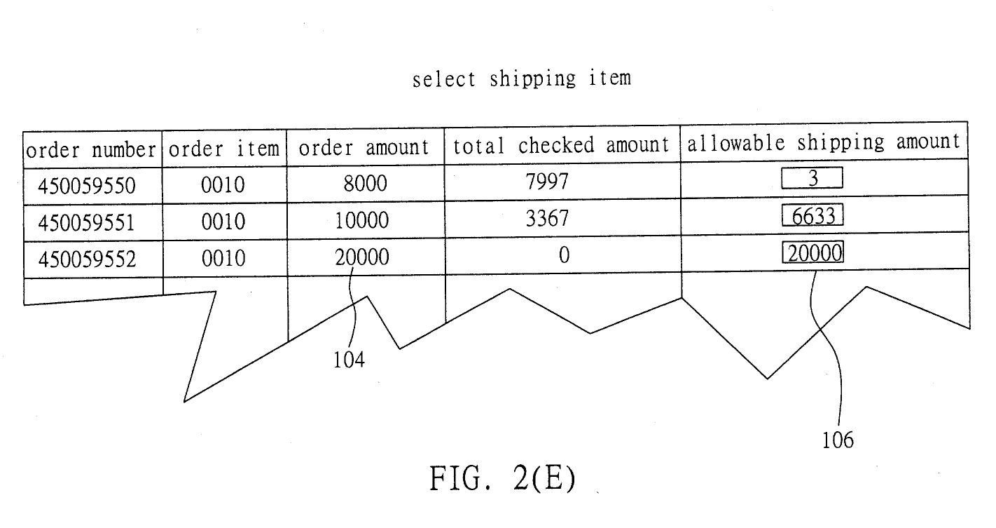

When the steps involved in the present invention are actually carried out, a web page is provided as illustrated in FIG. 2(A) for the user to enter the user name and identification code. First of all, the user of the purchase end enters the user name and the identification code in a user name column 100 and an identification column 102, respectively, such that the user identity verification module 52 may be able to search from the user files 51 in the user database 50 for the user's level authorized by the system for managing product delivery. Referring to FIG. 2(B), an appropriate web page is displayed according to the level, from which the purchasing end user can search or enter the data. Next, with the search data entered, the purchasing end user can search from the order files 61 in the order database 60 for the order detail using the invoice searching module 62. Referring to FIG. 2(C), a required order quantity also needs to be entered in a order quantity column 104 using the invoice modification module 63. After that, the delivery quantity counting module 64 is commanded to execute an alternative calculation of the order quantity and total checked quantity saved in the order files 61 in the order database 60, so as to obtain an upper limit and lower limit for the allowable delivery quantity before saving the data in the order files 61 in the order database 60. Referring to FIG. 2(A) again, the delivering end user may follow the purchasing end user's log in the steps as described previously. Referring to FIG. 2(D), the delivering end user enters the appropriate web page according to the authority level to search or input the data. The system for managing product delivery is commanded to display the search data inputted by the delivering end user using the invoice searching module 62. Referring to FIG. 2(E), the order detail to be searched is listed on the web page including the details including the order quantity, the total checked quantity, the upper limit and lower limit for the allowable delivery quantity, wherein the allowable delivery quantity column 106 can be modified on a delivery list web page using the invoice modification module 63 depending on the actual allowable delivery quantity.

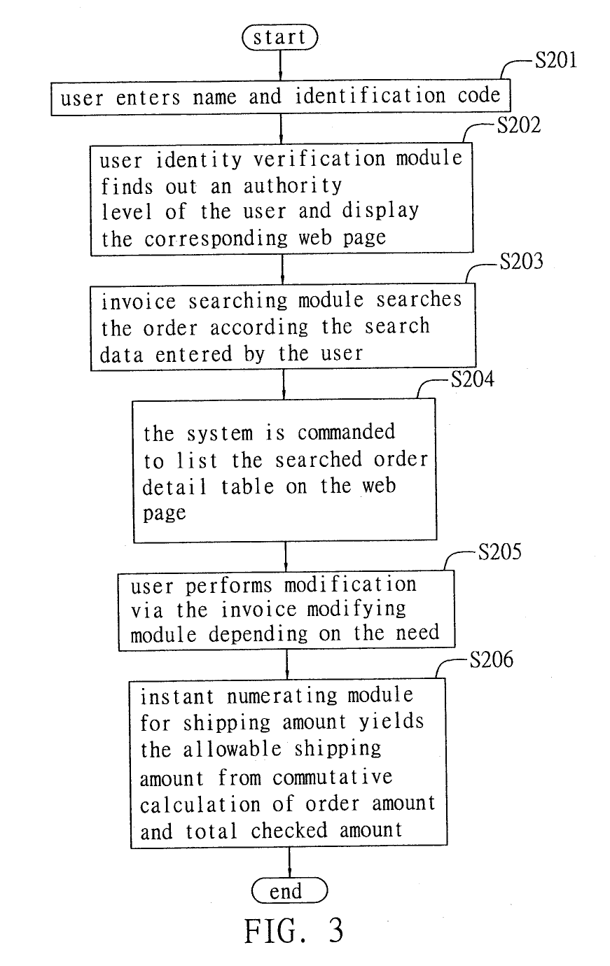

Referring to FIG. 3, the process steps involved in the method for managing the product delivery according to the present invention are illustrated. First of all, the purchasing end user or the delivering end user needs to link the browser 21 of the purchasing end terminal device 20 or the browser 31 of the delivering end terminal device 30 to the system for online managing product delivery 1 through the web communication 2. Then, the process moves on to step S201.

In step S201, the user inputs the user name and the identification code. Then, the process moves on to step S202.

In step S202, the user identity verification module 52 is commanded to search from the user files 51 in the user database 50 for the user level authorized by the system for managing product delivery, and to display the appropriate web page according to the user level, from which the user can search or input the data. Then, the process moves on to step S203.

In step S203, the invoice searching module is commanded to search from the order files 61 in the order database 60 for the order detail according to the search data inputted by the user. Then, the process moves on to step S204.

In step S204, the system for managing product delivery lists the searched order detail. Then, the process moves on to step S205.

In step S205, the purchasing end user inputs the order quantity currently required in the order quantity column 104 using the invoice modification module 63. Then, the process moves on to step S206.

In step S206, the delivery quantity counting module 64 performs an alternative calculation of the order quantity and total checked quantity, which are saved as the order files 61 in the order database 60, so as to obtain the upper limit and lower limit for the allowable delivery quantity before saving the data to the order files 61 in the order database 60. As a result, when the delivering end user searches the order detail, the search can be carried out online for the most updated order information provided by the purchasing end user, so as to achieve the online management for the product delivery.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for online managing product delivery by adopting a system for online managing product delivery, whereby a user of a terminal device manages product delivery online through a web communication system, the system for managing product delivery comprising a stock managing work station for establishing a plurality of order files and a plurality of user files, an order database for storing the plurality of order files, and a user database for storing the plurality of user files, the method comprising steps of:
(1) entering an identification code using the terminal device by the user, wherein the identification code enables the user identity verification module to search from the user database for an authority level entitled by the system for online managing product delivery to display an appropriate web page based on the authority level, so that the user from a purchase end can search and enter information;
(2) searching from the order files in the order database for the order details using an invoice searching module by the user according to a search information entered by the user;
(3) entering a quantity of current order using an invoice modification module by the user; and
(4) commanding a delivery quantity counting module to execute a reciprocal calculation of a quantity of the order and a total checked quantity saved in the order database to obtain an allowable delivery quantity before saving in the order database, so that the users from the purchase end and a delivery end can check the allowable delivery quantity online.

2. The method of claim 1, wherein the system for online managing product delivery is constructed within a web server.

3. The method of claim 1, wherein the system for online managing product delivery comprising:
a user identity verification module, for searching from the user database of the system for online managing product delivery for corresponding files, so that the authority level of the user is judged based on the identification data entered by the user;
an invoice searching module, for searching from the order database of the system for online managing product delivery for corresponding files, so that the user can search the order details and delivery list details online;
an invoice modification module, for altering the order details and delivery details, and recording the altered order details in the order database of the system for online managing product delivery; and
a delivery quantity counting module, for searching from the order database of the system for online managing product delivery for the order data, so as to count a quantity of the current stock, a maximum quantity of the stock, and a quantity currently ordered by the user from the purchase end.

4. The method of claim 1, wherein the web communication system comprises Internet.

5. The method of claim 1, wherein the web communication system comprises Intranet.

6. The method of claim 1, wherein the web communication system comprises Extranet.

7. A system for online managing product delivery, whereby a user of a terminal device manages product delivery online through a web communication system, the system for managing product delivery comprising:
a stock managing work station, for establishing a plurality of order files and a plurality of the user files;
an order database linked to the stock managing work station, for storing the plurality of order files; and
a user database linked to the stock managing work station, for storing the plurality of the user files.

8. The system of claim 7, wherein the system for online managing product delivery is constructed within a web server.

9. The system of claim 7, wherein the system further comprising:
a user identity verification module, for searching from the user database of the system for online managing product delivery for corresponding files, so that an authority level of the user is judged based on the identification data entered by the user;
an invoice searching module, for searching from the order database of the system for online managing product delivery for corresponding files, so that the user can search the order details and delivery list details online;
an invoice modification module, for altering the order detail and delivery detail, and recording the altered order details in the order database of the system for online managing product delivery; and
a delivery quantity counting module, for searching from the order database of the system for online managing product delivery for the order data, so as to count a quantity of the current stock, a maximum quantity of the stock, and a quantity currently ordered by the user from the purchase end.

10. The system of claim 7, wherein the web communication system comprises Internet.

11. The system of claim 7, wherein the web communication system comprises Intranet.

12. The system of claim 7, wherein the web communication system comprises Extranet.
